(19) United States
(12) Patent Application Publication
(10) Pub. No.: US 2019/0228644 A1
(43) Pub. Date: Jul. 25, 2019

(54) SERVER DEVICE AND INFORMATION COLLECTION SYSTEM

(71) Applicant: TOYOTA JIDOSHA KABUSHIKI KAISHA, Toyota-shi (JP)

(72) Inventor: Ryokichi ONISHI, Tokyo (JP)

(73) Assignee: TOYOTA JIDOSHA KABUSHIKI KAISHA, Toyota-shi (JP)

(21) Appl. No.: 16/253,396

(22) Filed: Jan. 22, 2019

(30) Foreign Application Priority Data
Jan. 25, 2018 (JP) 2018-010751

(51) Int. Cl. G08G 1/01; G06F 16/29; G09B 29/00; G01C 21/26

(52) U.S. Cl. CPC G08G 1/0125; G08G 1/0108; G01C 21/26; G09B 29/003; G06F 16/29

(57) ABSTRACT

A server device for collecting a plurality of types of data that are acquired by a plurality of terminals and include duplicate data, the server device comprises an issuer configured to issue an information request in which one or a plurality of attributes of required data are described; a data receptor configured to receive data acquired by each of the terminals; and a plan creator configured to determine a plan including a timing when a new information request for, of the plurality of types of data, data that is not acquired by the server device is issued after the issue of the information request, wherein the issuer issues the information request according to the plan.

### CROSS REFERRENCE TO THE RELATED APPLICATION

This application claims the benefit of Japanese Patent Application No. 2018-010751, filed on Jan. 25, 2018, which is hereby incorporated by reference herein in its entirety.

### BACKGROUND

### Technical Field

The present invention relates to a server device, an information collection system, and a program.

### Description of the Related Art

In recent years, there is proposed a technique for collecting information from a plurality of terminals uniformly.

Japanese Patent Application Publication No. 2008-242805 discloses a technique that allows a server device to automatically collect log information of a user terminal in the case where a user permits the collection.

In Japanese Translation of PCT Application No. 2005-521950, contents collected by a server device are reduced by executing filtering serving as a selection process of a reception message a plurality of times in a publish/subscribe network.

### SUMMARY

In addition, there is a technique for collecting a plurality of types of data (images) from a vehicle and generating a map in a given area. In the case where the above-described information collection technique is used, data is collected from a plurality of vehicles uniformly, and hence duplication of data occurs. Consequently, a problem arises in that a large amount of identical data is transmitted, and traffic and the amount of data acquired by a server device are thereby increased.

To cope with this, an object of the present invention is to provide a technique for efficiently collecting target contents in the case where a plurality of terminals may have contents that can be regarded as the same contents.

In order to achieve the above object, a server device issues an information request at an effective timing in the present invention. Hereinbelow, the number of contents that are acquired by the server device while duplication is permitted is referred to as “the number of times of acquisition”, the number of types of contents that are already collected from a plurality of types of contents by the server device is referred to as “the number of collected types”, and a ratio of the number of collected types to the number of types of contents is referred to as “a collection ratio”.

When the data collection is performed in the manner described above, the collection ratio (the number of collected types/the number of types of contents) increases immediately after the start of acquisition of contents, but the increase of the collection ratio slows down as the number of times of acquisition of contents increases (a so-called picture matching problem). To cope with this, the server device informs the terminal of desired information at an effective timing, and increases the collection ratio by receiving only the desired information. Note that the target collection ratio of contents may be set to 100% (all types), and may also be set to, e.g., 90%.

The present invention in its one aspect provides a server device for collecting a plurality of types of data that are acquired by a plurality of terminals and include duplicate data, the server device comprising an issuer configured to issue an information request in which one or a plurality of attributes of required data are described; a data receptor configured to receive data acquired by each of the terminals; and a plan creator configured to determine a plan including a timing when a new information request for, of the plurality of types of data, data that is not acquired by the server device is issued after the issue of the information request, wherein the issuer issues the information request according to the plan.

According to this configuration, the server device can collect the data efficiently by acquiring only the unacquired data after the new information request. Note that the timing of the information request is not particularly limited. In addition, the information request may be performed a plurality of times.

The information request is used to request the terminal to collect data directly or indirectly from the server device. The new information request may inform the terminal of information desired by the server device, and may also inform the terminal of unnecessary information (e.g., information that is already acquired by the server device).

Further, the plan creator may determine the timing when the new information request is issued, such that a predicted value of the number of times of acquisition of data required for the number of types of data collected by the server device to reach a predetermined target number is minimized.

The issue timing is determined by the solver by using a relational expression between the collection ratio and the normalized number of times of acquisition, and the issue timing may also be determined analytically by using an approximation. For example, the issue timing may be determined by performing m-th approximation by using the Maclaurin expansion and solving a differential equation. Specifically, in the present aspect, the plan creator may issue the new information request at a timing when a value, which is obtained by dividing the number of times of acquisition of data that is collected by the server device from when a previous information request is issued to when the new information request is issued by the number of types of data that are not acquired when the previous information request is issued, is equal to α shown below:

α=−{1n(1−y/n)}/2

where y is a difference between the predetermined target number and the number of collected types of data that are already collected when the previous information request is issued, and n is the number of types of data that are not acquired when the previous information request is issued.

Note that the timing of the new request issue is not limited to the above-described timing that minimizes the predicted value, and it is only necessary that the predicted value of the number of times of acquisition of data for achieving the target collection ratio be less than the predicted value of the number of times of acquisition in the case where the new request issue is not performed.

Further, the plan creator may repeatedly execute a process for determining the timing when the new information request is issued after the issue of the information request to determine a plurality of the timings when the new information request is issued, and the issuer may issue the new information request at each of the timings.

Note that the timing of the information request may be determined on the assumption that the information request is performed a plurality of times, and may also be determined according to an acquisition situation.

Further, the plan creator may repeatedly determine the timing when the new information request is issued until an effect obtained by performing the new information request to reduce the predicted value becomes less than a cost required for the issue of the new information request.

The effect is based on the number of times of acquisition of data that corresponds to a reduction achieved by performing the new information request, and includes, e.g., reduced data traffic, a storage capacity, and process time required for acquisition. The cost is based on the new information request, and includes, e.g., traffic and time required for the information request. With this configuration, the server device performs control such that an inefficient information request is not performed.

Further, the information request may be information indicative of an attribute of data that is already acquired by the server device.

Note that the information request may be the information indicative of the attribute of the data that is not acquired by the server device, and may also be acquired or unacquired data itself.

Further, the information indicative of the attribute of the data that is already acquired by the server device may be indicated by using a Bloom filter.

The Bloom filter is a data structure used to determine whether or not an element is included in a set. The Bloom filter is a filter that is represented by a predetermined number of bits, and is obtained by a bitwise logical sum (OR) of a hash value (a value obtained by the hash function) of retained information. In the case where change is caused by a logical product (AND) of the hash value of given information and the filter, the information is not included in the retained information. Herein, a false positive (to determine that an absent element is present) can be a problem. However, it is possible to reduce the incidence of the false positive by providing a sufficient number of bits of the Bloom filter according to the number of pieces of information (see S. Pontarelli, M. Ottavi: Error Detection and Correction in Content Addressable Memories by Using Bloom Filters, IEEE Trans. on Computers, vol. 62, no. 6, pp. 1111-1126 (2013)). Note that the information indicative of the attribute of the data is not limited to the above information, and may also be information indicated by using, e.g., a counting filter or the like.

The present invention in its another aspect provides an information collection system comprising the server device and; one or a plurality of terminals, wherein the server device collects data acquired in each of the terminals, each of the terminals includes an information request receptor configured to receive an information request issued from the server device; a data acquirer configured to acquire the data; and an information transmitter configured to transmit the data to the server device, wherein the information transmitter transmits information that the server device requires in a case where the terminal receives the information request from the server device.

Further, each of the terminals may suspend acquisition of data that is not requested in the information request, and may abandon the data in a case where the terminal stores the data.

With this configuration, it is possible to reduce the cost of the terminal required for data acquisition.

Further, the data may be map data, and each of the terminals may be one of a plurality of mobile terminals, and may acquire the map data and transmits the map data to the server device.

An example of the terminal includes the mobile terminal (e.g., a vehicle), and the map data suitable for a purpose is generated from image data of a road acquired by the mobile terminal. An example of the data in this case includes traffic information such as the type of the road, the number of lanes or the shape thereof, the presence or absence of a pedestrian waking across the road, the presence or absence of an oncoming vehicle or a vehicle in front, the amount of traffic (density), change of a traffic light, weather, or a time of day. In addition, the attribute of the map data is not particularly limited but is preferably position information. With this, the duplication of the image data acquired by the server device is prevented by preventing the duplication of the position information.

The present invention in its another aspect provides an information collection method of a server device for collecting a plurality of types of data that are acquired by a plurality of terminals and include duplicate data, the information collection method comprising an issue step of issuing an information request in which one or a plurality of attributes of required data are described; a data reception step of receiving data acquired by each of the terminals; and a plan creation step of determining a plan including a timing when a new information request for, of the plurality of types of data, data that is not acquired by the server device is issued after the issue of the information request, wherein in the issue step, the information request is issued according to the plan.

The present invention in its another aspect provides an information collection method of an information collection system that includes the server device and one or a plurality of terminals and in which the server device collects data acquired in each of the terminals, the method comprising an information request reception step of causing each of the terminals to receive an information request issued from the server device; a data acquisition step of causing each of the terminals to acquire the data; and an information transmission step of causing each of the terminals to transmit the data to the server device, wherein in the information transmission step, information that the server device requires is transmitted in a case where the terminal receives the information request from the server device.

In addition, an aspect of the present invention is a program for causing a computer to execute each step of the above information collection methods.

Note that the present invention can be considered as a server device including at least part of the above units, and an information collection system. In addition, the present invention can also be considered as an information collection method. Further, the present invention can also be considered as a program for causing a computer to execute the above information collection method. The above processes and units can be freely combined and implemented as long as no technical contradiction arises.

According to the present invention, it becomes possible to efficiently collect target contents in the case where a plurality of terminals may have contents that can be regarded as the same contents.

### BRIEF DESCRIPTION OF THE DRAWINGS

FIG. 1 is a system schematic diagram of an information collection system according to an embodiment;

FIG. 2 is a functional block diagram of each of a server device and a terminal according to the embodiment;

FIG. 3 is a flowchart showing a plan creation process of the server device according to the embodiment;

FIG. 4 is a flowchart showing a process for calculating a timing of a request issue of the server device according to the embodiment;

FIG. 5 is a view showing a relationship between a normalized acquisition number of data and a collection ratio according to the embodiment;

FIG. 6 is a view showing an example of an effect obtained by performing the request issue according to the embodiment;

FIG. 7 is a view showing an example of the effect obtained by performing the request issue according to the embodiment;

FIG. 8 is a view showing an example of the effect obtained by performing the request issue according to the embodiment;

FIG. 9 is a view showing an example in which the request issue according to the embodiment is repeatedly performed;

FIG. 10 is a flowchart showing a request issue process of the server device according to the embodiment; and

FIG. 11 is a view showing an example of the effect based on the request issue according to the embodiment.

### DESCRIPTION OF THE EMBODIMENTS

(Embodiment)

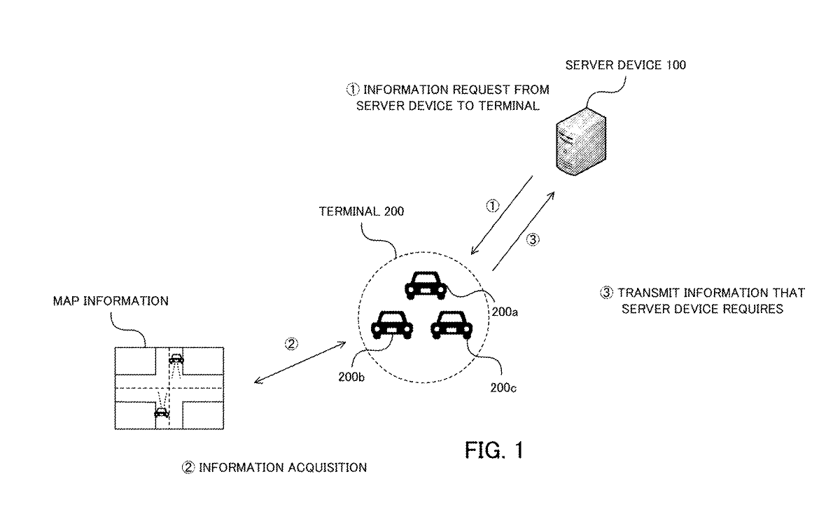

Hereinbelow, an embodiment of the present invention will be described. An information collection system according to the present embodiment is a system in which a server device collects map data (image) from a plurality of vehicles (terminals). FIG. 1 is a system schematic diagram of the information collection system according to the present embodiment.

Outline

In the present embodiment, a server device 100 issues an acquisition instruction of map data (information request issue) to a terminal 200. The terminal 200 acquires the map data (image) according to the acquisition instruction from the server device 100, and transmits the map data to the server device 100. Subsequently, the server device 100 collects (a plurality of types of) the map data transmitted from the terminal 200 to generate a map in a given area.

Herein, the server device 100 issues a request (new information request) to the terminal 200 such that “only data that is not acquired by the server device 100 is transmitted at a timing when the server device 100 has acquired a certain amount of data”. The plan of the timing of issue of the new information request is created in advance based on a precondition (creation of the plan of the new information request). Examples of the precondition include the number of types of the map data to be acquired, and a target collection ratio. The server device 100 performs the new information request according to the plan. Hereinbelow, the system configuration of the information collection system according to the present embodiment, a plan creation process, a request issue process, an example of the application of the embodiment, and advantageous effects of the present embodiment will be described one by one.

System Configuration

The collection system according to the present embodiment includes the server device 100 capable of communication via a network, and the terminals 200 (200a, 200b, and 200c) mounted on a plurality of vehicles (FIG. 1).

Server Device 100

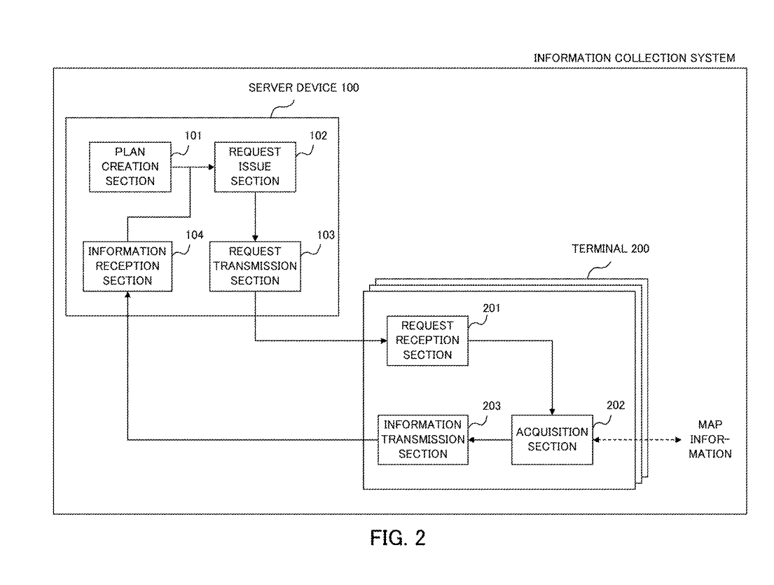

FIG. 2 is a functional block diagram of the server device 100. The server device 100 is an information processing device (computer) that includes an arithmetic unit (processor), a memory, a storage device, and an input/output device. The server device 100 executes a program stored in the storage device, and functions of the server device 100 such as a plan creation section 101, a request issue section 102, a request transmission section 103, and an information reception section 104 are thereby provided. Part or all of the functions may be implemented by using a dedicated logic circuit such as an ASIC or an FPGA.

Herein, the information request is a start instruction used to request each terminal 200 to acquire data directly or indirectly from the server device 100. Herein, specifically, the information request is information indicative of the attribute of data, and the attribute thereof is preferably position information for the map data. In addition, the server device 100 performs the new information request according to the number of times of reception (acquisition) of data acquired by the terminal 200. The new information request is an instruction for requesting data desired by the server device 100 (unacquired data) that is issued to the terminal 200, and it is possible to perform the new information request a plurality of times. The server device 100 can prevent duplication of image data acquired by the server device 100 by performing the new information request to prevent duplication of the position information.

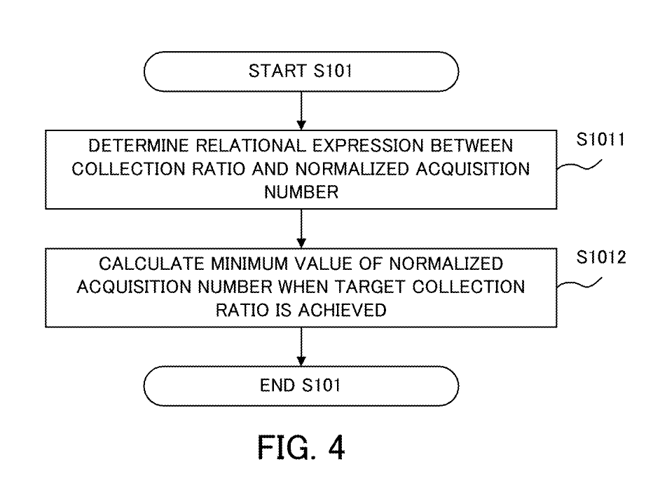

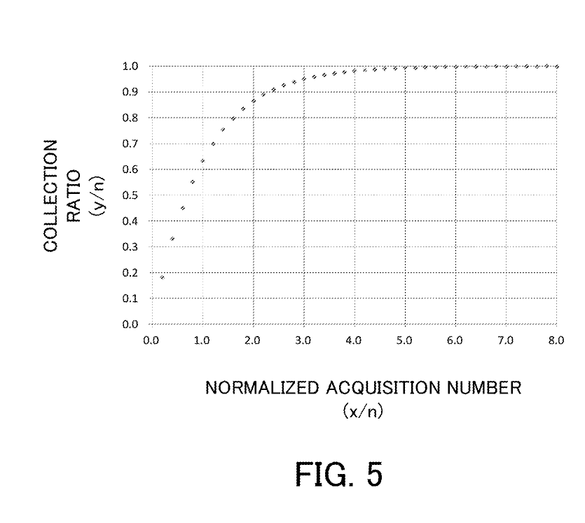

The plan creation section 101 is a functional section that creates a plan including the timing when the information request is issued by the server device 100. The plan creation section 101 creates the plan of the issue timing of the new information request in advance based on the precondition (the number of types of the map data, the target collection ratio or the like), and records the result in a storage section that is not shown. In the present embodiment, the plan creation section 101 determines the issue timing of the new information request, such that a predetermined target collection ratio is achieved by using the minimum number of times of acquisition (predicted value). The detail of the plan creation section 101 will be described in a process description that uses flowcharts in FIGS. 4 and 5 described later. Note that the issue timing of the information request is not limited to the case where the above prediction value is minimized. For example, the plan creation section 101 may create the plan such that the information request is issued at predetermined time intervals, and may also create the plan such that the information request is issued when the collection ratio reaches a predetermined value.

The request issue section 102 is a functional section that issues the information request

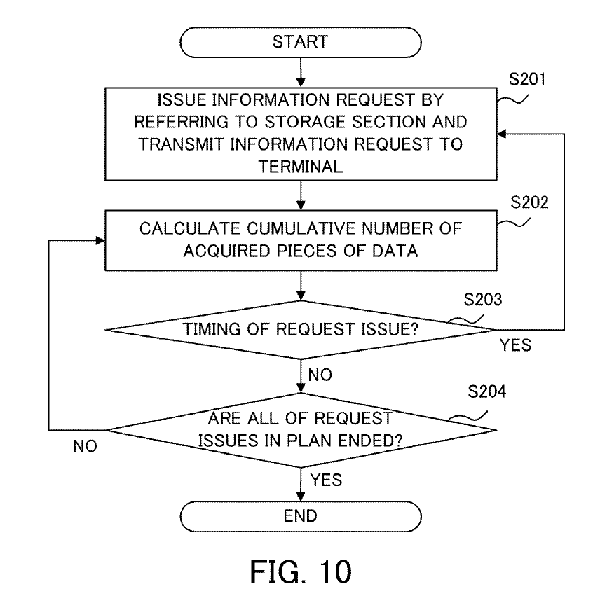

OP- 18102 -US according to the plan (issue timing) outputted by the above plan creation section 101, and the cumulative number of acquired pieces of data (the number of pieces of data that the server device 100 acquires from a plurality of the terminals 200) described later. Specifically, the request issue section 102 issues the information request when the cumulative number of acquired pieces of data reaches the above issue timing. In the information request according to the present embodiment, the attribute of data that is already acquired by the server device 100 is described. Specifically, the request issue section 102 indicates the attribute of acquired data by using a Bloom filter. The Bloom filter is a data structure used to determine whether or not an element is included in a set. The detail of the request issue section 102 will be described in a process description that uses a flowchart in FIG. 10 described later. Note that the request issue section 102 issues the request based on the plan that is created in advance in the present embodiment, but the request issue timing may be determined according to the number of times of acquisition or the number of collected types. For example, the request issue section 102 may issue the information request in the case where the ratio of the number of collected types to the number of times of acquisition per predetermined time becomes equal to or less than a predetermined threshold value. In addition, the information request is not limited to the information indicated by using the above-described filter, and may also be attribute information indicated by using, e.g., a counting filter or the like.

The request transmission section 103 is a functional section that transmits the request to the terminal 200 according to the issue of the information request described above. The request is transmitted to each target terminal 200 in the present embodiment, but the request may also be transmitted only to a specific terminal (e.g., a terminal positioned in a specific area). Note that the request transmission section 103 may transmit the request to the terminal 200 indirectly via another server device or a device such as a terminal.

The information reception section 104 (data reception unit) is a functional section that receives the map data that is acquired and transmitted by the terminal 200 in response to the above request. In the present embodiment, the information reception section 104 receives the above map data, and calculates the number of received pieces of data (the cumulative number of acquired pieces of data) and records the number thereof in a storage section that is not shown.

Terminal 200

FIG. 2 is a functional block diagram of the terminal 200. The terminal 200 is an information processing device (computer) that includes an arithmetic unit (processor), a memory, a storage device, and an input/output device. The terminal 200 executes a program stored in the storage device, and functions such as a request reception section 201, an acquisition section 202, and an information transmission section 203 are thereby provided. Part or all of the functions may be implemented by a dedicated logic circuit such as an ASIC or an FPGA.

In the present embodiment, the terminal 200 acquires the map data by receiving the above-described acquisition instruction (information request) from the server device 100. Subsequently, the terminal 200 transmits the acquired map data to the server device 100. In addition, the terminal 200 transmits only data requested by the server device 100 to the server device 100 by receiving the above-described new information request. Note that the terminals 200 are devices mounted on a plurality of vehicles in the present embodiment, but the above-described functions may be provided by using a device such as a smartphone or a wearable terminal as the terminal 200.

The request reception section 201 (information request reception unit) is a functional section that receives the information request issued from the server device 100. Note that the request reception section 201 may receive the request from the server device 100 indirectly via another server or a device such as a terminal.

The acquisition section 202 is a functional section that acquires data corresponding to the information request of the server device 100. In the present embodiment, the acquisition section 202 acquires traffic information such as the white line or the like by using an imaging device mounted on the vehicle. The acquired data is recorded in the storage device of the terminal 200 that is not shown.

In the present embodiment, the acquisition section 202 periodically acquires image data according to the above acquisition instruction and transmits only requested image data to the server device 100, but the acquisition section 202 may acquire only the requested image data and transmits the image data to the server device 100. In this case, the requested image data denotes the map data of a request place.

Note that, in the case where the request reception section 201 receives the above-described new information request, the acquisition section 202 may suspend the acquisition of data already acquired by the server device 100 in the information request, and abandon the data in the case where the data is already recorded. The traffic information is not limited to the white line, and may also be traffic information such as, e.g., the type of a road, the number of lanes or the shape thereof, the presence or absence of a pedestrian waking across the road, the presence or absence of an oncoming vehicle or a vehicle in front, the amount of traffic (density), change of a traffic light, weather, or a time of day. Note that data acquired by the acquisition section 202 is not limited to the traffic information.

The information transmission section 203 is a functional section that transmits information acquired by the acquisition section 202 to the server device 100. In the present embodiment, the information transmission section 203 performs information transmission every time the map data is acquired, but may perform the transmission at predetermined time intervals. For example, the information transmission section 203 may perform the transmission every five minutes (every predetermined time), every time 1 km of driving is performed (every time a predetermined distance of driving is performed),or every time ten pieces of data are acquired (every time a predetermined number of pieces of data are acquired). In addition, the information transmission section 203 may transmit the information according to the instruction of a user who uses the vehicle on which the terminal 200 is mounted. Note that the information transmission section 203 may transmit the information to the server device 100 indirectly via another server device or a device such as another terminal.

Plan Creation Process

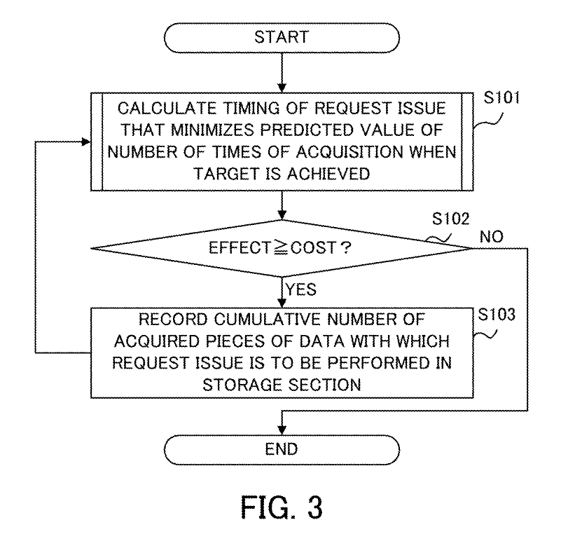

With reference to FIG. 3, a process performed by the plan creation section 101 will be described. Note that, in this flowchart, individual processes are depicted so as to be performed in an order shown in the flowchart. However, the processes do not necessarily need to be performed in this order, and the processes may be executed in a different order, or each process may also be executed in parallel with a plurality of the processes.

In Step S101, the plan creation section 101 calculates the request timing such that the predicted value of the number of times of acquisition when the target collection ratio (the number of collected types/the number of types) is achieved is minimized. The detail of the calculation process will be described in the process description that uses the flowchart in FIG. 4 described later.

In Step S102, the plan creation section 101 compares an effect obtained by issuing the information request with the cost of the issue.

The effect is calculated based on the predicted value of the number of times of acquisition of data that is reduced by the new information request. Specifically, the plan creation section 101 uses a value calculated according to “amount of data of one acquired piece of data×reduction in the number of times of acquisition” as the effect. The reduction in the number of times of acquisition corresponds to the number of times of acquisition by which the number of times of acquisition (predicted value) when the target collection ratio is achieved is reduced by performing the new request issue.

The cost is calculated based on data traffic that is generated by the new information request. Specifically, the plan creation section 101 uses a value calculated according to “amount of data of information request×number of terminals 200” as the cost.

In the case where the effect in the information request is not less than the cost (S102-YES), the process proceeds to Step S103. In the case where the effect in the information request is less than the cost (S102-NO), the plan creation section 101 ends the plan creation process (i.e., the additional new request issue is not performed). With this, the server device 100 performs control such that an inefficient information request is not performed.

In Step S103, the number of times of acquisition with which the request issue is to be performed is recorded in a storage section that is not shown, and the process proceeds to Step S101. The plan creation section 101 performs the information collection more efficiently by creating the plan such that the request issue timing is repeatedly calculated until the effect becomes less than the cost.

Request Issue Timing Calculation Process (S101)

The detail of S101 described above will be described by using the flowchart shown in FIG. 4.

In Step S1011, the plan creation section 101 determines relational expressions between the collection ratio and the normalized number of times of acquisition (hereinafter referred to as the normalized acquisition number) (Expressions (1) to (4)). Hereinbelow, let n be the number of types of information, let x be the number of times of acquisition, and let y be the number of collected types. In addition, it is assumed that the relative frequency of data is uniform.

First, when let Xₖ be the number of times of acquisition (the number of times) required to newly obtain another type of information in a state in which k types of information are held, the probability Pₘ that Xₖ is m (m: 1 to n) is equal to the probability of a success after (m-1) failures, and is given by the following Expression (1).

$$[ Math . 1 ]$$

$${P}_{m} = {( \frac{k}{n} )}^{m - 1} \times ( 1 - \frac{k}{n} ) \qquad ( 1 )$$

Next, the expected value E[Xₖ] of Xₖ is determined by the following Expression (2).

$$[ Math . 2 ]$$

$$\begin{matrix}E [ {X}_{k} ] = {\sum }_{m = 1}^{∞} m \times {P}_{m} \\ = {\sum }_{m = 1}^{∞} m \times {( \frac{k}{n} )}^{m - 1} \times ( 1 - \frac{k}{n} ) \\ = \frac{n}{n - k}\end{matrix} \qquad ( 2 )$$

Based on the foregoing, the predicted value×of the number of times of acquisition required to obtain y types is given by the following Expression (3).

$$[ Math . 3 ]$$

$$\begin{matrix}x = E [ {X}_{0} + {X}_{1} + ⋯ + {X}_{y - 1} ] = \frac{n}{n} + \frac{n}{n - 1} + ⋯ + \frac{n}{n - ( y - 1 )} \\ = n ( \frac{n}{n} + \frac{1}{n - 1} + ⋯ + \frac{1}{1} ) - n ( \frac{1}{n - y} + ⋯ + \frac{1}{1} ) \\ \approx n \times ln ( n ) - n \times ln ( n - y ) = n \times ln ( \frac{n}{n - y} )\end{matrix} \qquad ( 3 )$$

Therefore, by permitting duplication in n types and using the predicted value y of the number of collected types in the case where the acquisition is performed×times, the relational expression between the normalized acquisition number (x/n) and the collection ratio (y/n) is the following Expression (4). FIG. 5 is a view representing Expression (4).

$$[ Math . 4 ]$$

$$\frac{y}{n} = 1 - exp ( - \frac{x}{n} ) \qquad ( 4 )$$

The description will be made returning to the flowchart in FIG. 4.

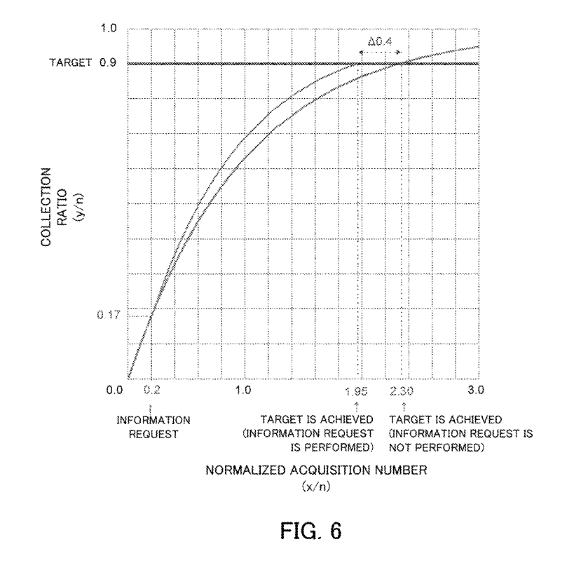

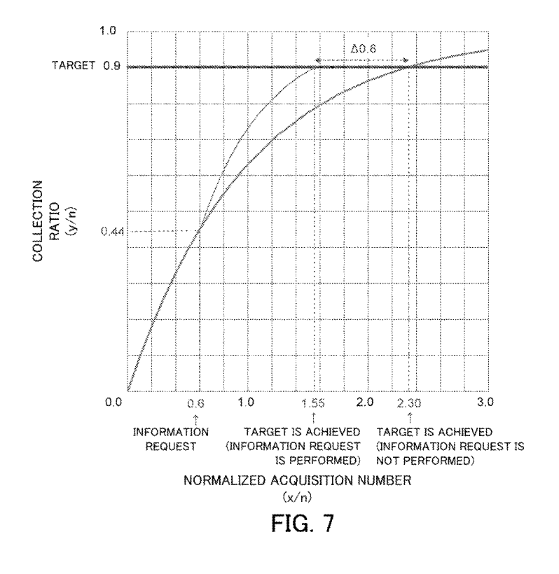

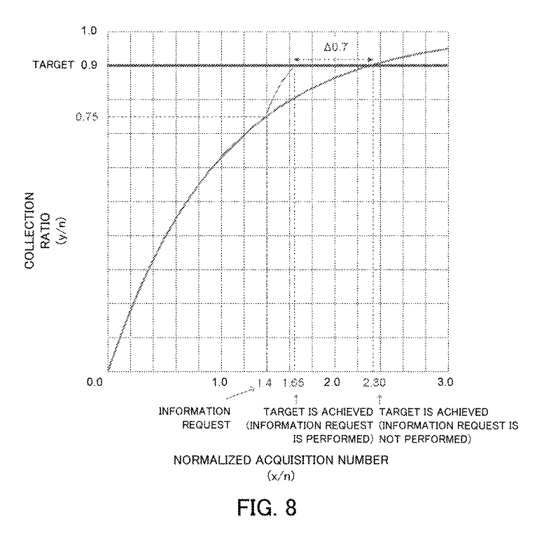

In Step S1012, the plan creation section 101 calculates the minimum value of the normalized acquisition number when the target collection ratio is achieved. In the present embodiment, the description will be made on the assumption that the target collection ratio is 0.9 (90%). However, the target collection ratio is not particularly limited, and a predetermined value (predetermined target number) may be used. Each of FIGS. 6 to 8 shows a result when the request issue is performed at a different timing. FIG. 6 is a view showing the normalized acquisition number in each of the case where the information request is not performed and the case where the information request is performed at a timing when the normalized acquisition number is 0.2. In FIG. 6, the predicted value of the normalized acquisition number when the target collection ratio of 0.9 is achieved is 2.30 in the case where the information request is not performed, and is 1.95 in the case where the information request is performed. Therefore, the predicted value of the normalized acquisition number when the target collection ratio is achieved is reduced by about 0.4. Similarly, FIG. 7 shows that the predicted value of the normalized acquisition number when the target collection ratio is achieved is reduced by about 0.8 in the case where the information request is performed when the normalized acquisition number is 0.6. In addition, FIG. 8 shows that the predicted value of the normalized acquisition number when the target collection ratio is achieved is reduced by about 0.7 in the case where the information request is performed when the normalized acquisition number is 1.4.

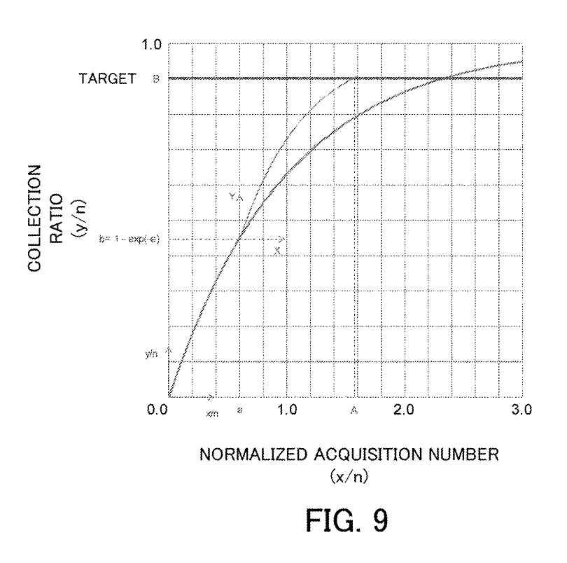

Thus, the early timing (state in which the normalized acquisition number is small) when the information request is performed is not necessarily appropriate, the late timing (state in which the normalized acquisition number is large) when the information request is performed is not necessarily appropriate, too, and there is a timing that allows obtainment of the maximum reduction effect. The server device 100 preferably reissues the information request at this timing. The timing that allows the maximum reduction effect, i.e., the minimum of the predicted value is determined by the following Expression (5).

$$[ Math . 5 ]$$

$$\begin{matrix}a = {arg min}_{a} A \\ = {arg min}_{a} \{ a - exp ( - a ) \times ( ln ( 1 - \frac{y}{n} ) + a ) \}\end{matrix} \qquad ( 5 )$$

where a is the normalized acquisition number (x/n) when the information request is performed, and A is the predicted value of the normalized acquisition number when the target collection ratio is achieved (FIG. 9).

In the case where the target collection ratio (y/n) is 0.9, the minimum value Aₘᵢₙ of the above-described predicted value A and the above-described normalized acquisition number a satisfy Aₘᵢₙ=1.470 and a=0.883 based on the calculation result of the solver. Therefore, the server device 100 performs the new information request when the normalized acquisition number is 0.883, and the predicted value of the number of times of acquisition is minimized. Note that the plan creation section 101 may determine the above-described normalized acquisition number a analytically by using an approximation. For example, the above-described normalized acquisition number a may be determined by performing m-th approximation of the above-described predicted value A by using the Maclaurin expansion and solving a differential equation dA/da=0. Specifically, the new information request may be issued at a timing when the normalized acquisition number a satisfies the following Expression (6).

$$[ Math . 6 ]$$

$$a = - \frac{ln ( 1 - \begin{matrix}y \\ n\end{matrix} )}{2} \qquad ( 6 )$$

Note that, in the case where the second or subsequent new information request is performed, the timing of the request issue may be determined in a manner similar to that described above by using n as the number of types of data that are not acquired at the time of the previous information request and using y as a difference between the predetermined target number and the number of collected types of data that are already collected at the time of the previous information request. In this case, it should be noted that the normalized acquisition number a is normalized using new n, and a is the normalized acquisition number from the previous request issue.

Request Issue Process

A process performed by the request issue section 102 will be described with reference to FIG. 10. Note that, in this flowchart, individual processes are depicted so as to be performed in an order shown in the flowchart. However, the processes do not necessarily need to be performed in this order, and the processes may be performed in a different order, or each process may also be executed in parallel with a plurality of the processes.

In Step S201, the request issue section 102 issues the information request based on the above plan by referring to a storage section that is not shown. The information request includes the attribute of data that is already acquired by the server device 100. Subsequently, the request transmission section 103 transmits the information request issued by the request issue section 102 to the terminal 200. With this, the server device 100 notifies the terminal 200 of unacquired data (desired data) and the terminal 200 transmits data other than the above-described acquired data, whereby the server device 100 prevents the collection of the acquired data (duplicate data).

In Step S202, the information reception section 104 receives information acquired and transmitted by the terminal 200. In addition, the information reception section 104 determines the cumulative number of acquired pieces of data serving as the total number of pieces of data that are received irrespective of duplication of contents.

In Step S203, the request issue section 102 refers to the plan recorded in the storage section to determine whether or not the cumulative number of acquired pieces of data has reached the timing of the new request issue. In the case where the request issue section 102 determines that the cumulative number thereof has reached the issue timing (S203-YES), the process proceeds to Step S201. In the case where the request issue section 102 determines that the cumulative number thereof has not reached the issue timing, the process proceeds to Step S204.

In Step S204, the request issue section 102 determines whether or not all of the request issues of the plan are ended. In the case where the request issue section 102 determines that all of the request issues of the plan are not ended (S204-NO), the process proceeds to Step S202. In the case where the request issue section 102 determines that all of the request issues of the plan are ended (S204-YES), the request issue section 102 ends the request issue process.

Example of Application of Embodiment

A description will be given of an example in which the above-described information collection system is applied to the collection of the map data of Tokyo. It is assumed that the number of types of the map data n is 12.5 million (roads in Tokyo having the total length of about 25,000 km are divided into sections each having the length of 2 m, and information on each section is collected), and the data size of one piece of data is 7.5 MB. Further, it is assumed that the terminals 200 are 400,000 vehicles (a plurality of mobile terminals), and the target collection ratio is 0.9 (target number of collected types: 11.25 million). Note that, when the information request to one vehicle requires the amount of data of 1.5 KB including the Bloom filter of 28 bits, the cost of the information requests to all vehicles is 600 MB (1.5 KB×400,000).

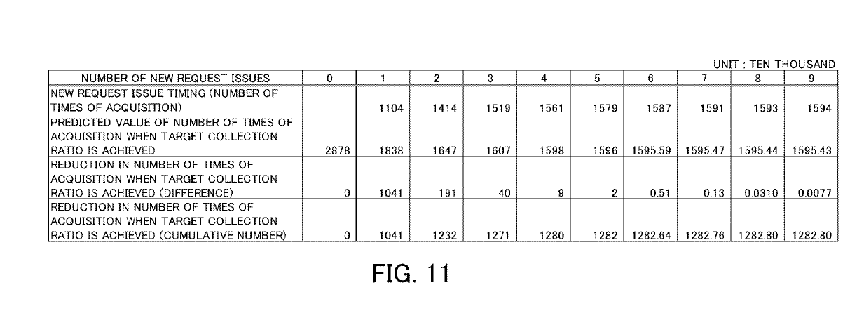

FIG. 11 shows an example of the effect based on the new request issue according to the present embodiment. In this case, the predicted value of the number of times of acquisition when the target collection ratio is achieved is 28.78 million in the case where the new request issue is not performed (0 times), and is reduced to 18.38 million in the case where the new request issue is performed once. Therefore, in the case where the new request issue is performed once, a difference in the predicted value of the number of times of acquisition (reduction) is about 10.41 million. The number of times of acquisition is reduced by performing the new information request a plurality of times in the same manner (the effect is increased).

Herein, a difference in the predicted value of the number of times of acquisition (reduction) in the ninth new information request is about 77 and the data size of one piece of data is 7.5 MB, and hence the effect is about 580 MB. In this case, the effect is less than the cost of the information request that is 600 MB. Therefore, the plan creation section 101 creates the plan such that the ninth new information request is not performed, and the plan is ended when the eighth new information request is performed. With this, while the predicted value of the number of times of acquisition for achieving the target collection ratio is 28.78 million in the case where the new information request is not performed, the predicted value thereof is 15. 95 million in the case where the new information request is performed eight times, and the amount of data is reduced by the amount of data corresponding to about 12.83 million pieces of data (about 96 TB).

Advantageous Effects of Present Embodiment

According to the present embodiment, the information collection system can reduce the predicted value of the number of times of acquisition of information by issuing the information request at an appropriate timing. In addition, the information collection system can achieve the target collection ratio with the minimum number of times of acquisition by repeatedly issuing the information request in the case where the cost of the information request is less than the effect.

(Modification)

In the above embodiment, the specific calculation method of each of the effect and the cost has been described, but the calculation method is not particularly limited. The effect and the cost may be calculated by using the index values of, e.g., the traffic, calculation time, collection time, and amount of data stored in a storage section (not shown).

In the above embodiment, the necessity to perform the new information request has been determined by comparing the effect with the cost in the plan creation process (S102), but the timing of the new request issue may be determined by using a predetermined number of times as the upper limit without performing the comparison. With this, it is not necessary to calculate the cost, and hence it is possible to perform the above-described plan creation process irrespective of the number of terminals.

In the above embodiment, the description has been made on the assumption that the map data (contents) occurs uniformly but, in many cases, the presence probability of actual information is not uniform. However, it is anticipated that information having similar presence probabilities is collected at the timing of the request issue, and hence the presence probability of the information is considered to be uniform approximately, and it is possible to use the above-described collection method. In the case where the collection ratio does not increase as planned because the presence probabilities of contents are not uniform and a difference between the predicted collection ratio and the actual collection ratio is not less than a predetermined threshold value, the new request issue may be performed before the next issue timing.

In the above embodiment, the description has been made by using the Bloom filter of 28 bits, but the filter size is not particularly limited. Note that, in the case where the number of types is about 10 million, it is possible to reduce the incidence of a false positive to a negligible level by using the Bloom filter having the filer size of 28 bits (see S. Pontarelli, M. Ottavi: Error Detection and Correction in Content Addressable Memories by Using Bloom Filters, IEEE Trans. on Computers, vol. 62, no. 6, pp. 1111-1126 (2013)).

In the above embodiment, the target collection ratio has been set to 90%, but the target collection ratio is not particularly limited. Theoretically, the number of times of acquisition for achieving the collection ratio of 100% is infinite, and hence it is possible to set the target collection ratio to, e.g., 90%, and the remaining 10% can be achieved by measurement that uses a vehicle for measurement.

(Others)

The configurations of the embodiment and the modification described above can be appropriately combined and used without departing from the technical idea of the present invention. In addition, the present invention may be appropriately modified and implemented without departing from the technical idea of the present invention.

What is claimed is:

1. A server device for collecting a plurality of types of data that are acquired by a plurality of terminals and include duplicate data, the server device comprising:
an issuer configured to issue an information request in which one or a plurality of attributes of required data are described;
a data receptor configured to receive data acquired by each of the terminals; and
a plan creator configured to determine a plan including a timing when a new information request for, of the plurality of types of data, data that is not acquired by the server device is issued after the issue of the information request, wherein
the issuer issues the information request according to the plan.

2. The server device according to claim 1, wherein
the plan creator determines the timing when the new information request is issued, such that a predicted value of the number of times of acquisition of data required for the number of types of data collected by the server device to reach a predetermined target number is minimized.

3. The server device according to claim 2, wherein
the plan creator issues the new information request at a timing when a value, which is obtained by dividing the number of times of acquisition of data that is collected by the server device from when a previous request is issued to when the new information request is issued by the number of types of data that are not acquired when the previous information request is issued, is equal to α shown below:
α=−{1n(1−y/n)}/2
where y is a difference between the predetermined target number and the number of collected types of data that are already collected when the previous information request is issued, and n is the number of types of data that are not acquired when the previous information request is issued.

4. The server device according to claim 2, wherein
the plan creator repeatedly executes a process for determining the timing when the new information request is issued after the issue of the information request to determine a plurality of the timings when the new information request is issued, and
the issuer issues the new information request at each of the timings.

5. The server device according to claim 4, wherein
the plan creator repeatedly determines the timing when the new information request is issued until an effect obtained by performing the new information request to reduce the predicted value becomes less than a cost required for the issue of the new information request.

6. The server device according to claim 1, wherein
the information request is information indicative of an attribute of data that is already acquired by the server device.

7. The server device according to claim 6, wherein
the information indicative of the attribute of the data that is already acquired by the server device is indicated by using a Bloom filter.

8. An information collection system comprising:
the server device according to claim 1 and;
one or a plurality of terminals, wherein
the server device collects data acquired in each of the terminals,
each of the terminals includes:
an information request receptor configured to receive an information request issued from the server device;
a data acquirer configured to acquire the data; and
an information transmitter configured to transmit the data to the server device, wherein
he information transmitter transmits information that the server device requires in a case where the terminal receives the information request from the server device.

9. The information collection system according to claim 8, wherein
each of the terminals suspends acquisition of data that is not requested in the information request, and abandons the data in a case where the terminal stores the data.

10. The information collection system according to claim 8, wherein
the data is map data, and
each of the terminals is one of a plurality of mobile terminals, and acquires the map data and transmits the map data to the server device.

11. An information collection method of a server device for collecting a plurality of types of data that are acquired by a plurality of terminals and include duplicate data, the information collection method comprising:
an issue step of issuing an information request in which one or a plurality of attributes of required data are described;
a data reception step of receiving data acquired by each of the terminals; and
a plan creation step of determining a plan including a timing when a new information request for, of the plurality of types of data, data that is not acquired by the server device is issued after the issue of the information request, wherein
in the issue step, the information request is issued according to the plan.

12. An information collection method of an information collection system that includes the server device according to claim 1 and one or a plurality of terminals and in which the server device collects data acquired in each of the terminals, the method comprising:
an information request reception step of causing each of the terminals to receive an information request issued from the server device;
a data acquisition step of causing each of the terminals to acquire the data; and
an information transmission step of causing each of the terminals to transmit the data to the server device, wherein
in the information transmission step, information that the server device requires is transmitted in a case where the terminal receives the information request from the server device.

13. A non-transitory computer readable storing medium recording a computer program for causing a computer to perform the method according to claim 11.
